(19) United States
(12) Patent Application Publication
(10) Pub. No.: US 2026/0140261 A1
(43) Pub. Date: May 21, 2026

(54) DEVICES SYSTEMS AND METHODS FOR DETECTING FLYING OBJECTS

(71) Applicant: Binyamin Yefet Sonovani, katsrin (IL)

(72) Inventor: Binyamin Yefet Sonovani, katsrin (IL)

(21) Appl. No.: 18/947,226

(22) Filed: Nov. 14, 2024

(51) Int. Cl. G01S 17/66; G01S 7/4865; G01S 17/48

(52) U.S. Cl. CPC G01S 17/66; G01S 7/4865; G01S 17/48

(57) ABSTRACT

This invention discloses a system and method for detecting and identifying flying objects, such as drones and aircraft, using a combination of laser range finding, radar, optical and thermal imaging, and acoustic sensing. Advanced algorithms fuse data from multiple sensors to enable accurate target detection, classification, tracking, and three-dimensional mapping in diverse environmental conditions. High-speed data acquisition and sophisticated algorithms provide precise measurements of target location, speed, size, and trajectory, even for partially transparent or reflective objects.

### FIELD

The present invention, in some embodiments thereof, relates to devices systems and methods for detecting one or more flying objects such as aircraft, more specifically, but not exclusively, to devices systems and methods for detecting aircraft such as aircraft-based parachutes, drones, and the like

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Existing methods for detecting flying objects often rely on single-sensor technologies, which have limitations in accuracy, range, and environmental adaptability. Radar systems are susceptible to interference and may be ineffective in cluttered environments. Optical systems are limited by visibility conditions, while acoustic systems suffer from noise pollution and lack precision. The current invention addresses these shortcomings by integrating multiple sensors and employing advanced data fusion and AI algorithms for improved accuracy and reliability. Known detection systems and devices include one or more of the following systems and methods:

Goal tracking and automated monitoring device: The Mission Tracking System (MTS) is designed to concurrently track and monitor multiple objectives such as the flying objective. Employing advanced algorithms, it analyzes target movements, forecasts trajectories, and autonomously pursues noteworthy targets. This serves to alleviate operator workload and enhance the efficacy of mission engagement.

Automatic Targeting System (ATS). An Automatic Targeting System (ATS) is a computerized system that utilizes advanced algorithms and data analysis techniques to automate the process of identifying, tracking, and engaging targets.

Sensor Integration: the ATS integrates various sensors, such as radar, sonar, electro-optical/infrared (EO/IR) sensors, and other data sources to collect information on potential targets. These sensors provide input data on the target's location, movement, size, shape, and other relevant parameters.

Data Processing and Fusion: The ATS employs data processing and fusion techniques to analyze sensor data. It applies algorithms to correlate, integrate, and extract information from the sensor inputs, including target identification, classification, and tracking.

Target Identification: The ATS utilizes pattern recognition algorithms, machine learning, and computer vision to identify potential targets within the collected sensor data. It compares acquired data with known signatures or patterns of targets to determine their presence and type.

Target Tracking: After target identification, the ATS employs tracking algorithms to continuously monitor and predict the target's movement. It calculates the target's position, speed, acceleration, and other parameters to maintain precise tracking.

The Automatic Targeting System is a computerized system that combines sensor inputs, data processing, and algorithms to automate the detection, classification, and tracking of potential targets. The system is capable of transmitting focal data, images, and relevant information to ground stations or alternative aircraft, thereby facilitating real-time awareness and coordination of situations.

Electro Optical Targeting System (EOTS). EOTS is a target identification, and tracking, including seamlessly integrating advanced electro-optical sensors and processing algorithms.

Electro-Optical Sensors: The EOTS incorporates a range of electro-optical sensors, including cameras, infrared detectors, and laser rangefinders. These sensors collectively capture images and data in both the visible light spectrum and the infrared spectrum, ensuring optimal performance in diverse lighting conditions.

Visual and Infrared Imaging: visual imaging captures images in the visible light spectrum, while infrared imaging detects heat signatures. This dual capability enables the EOTS to identify targets, such as flying target in low-light or obscured environments, providing operational flexibility for day and night operations.

Target Identification and Tracking: the EOTS utilizes image processing algorithms for target identification and tracking. These algorithms analyze captured images, considering changes in position, shape, and other characteristics. The system autonomously tracks the flying targets with precision.

Laser Designator: integrated into the EOTS systems is a laser designator component, such as laser sources emitting laser energy for precise target designation. The accompanying laser stabilizer ensures accurate targeting, contributing to the system's overall effectiveness.

Target Detection Algorithms: EOTS systems feature target detection algorithms based on pattern recognition and image analysis. These algorithms compare acquired images with known target signatures, enhancing the system's ability to detect and identify specific targets or objects of interest.

Image Stabilization: to compensate for platform vibrations or movement, the EOTS includes image stabilization mechanisms. These mechanisms ensure stable and clear imaging during target acquisition and engagement, a critical aspect for maintaining operational effectiveness.

Data Processing and Fusion: the EOTS incorporates advanced data processing and fusion capabilities. Information from multiple sensors and sources is seamlessly integrated, enhancing overall situational awareness. This capability contributes significantly to the system's effectiveness in dynamic operational scenarios.

In conclusion, the Electro Optical Targeting System (EOTS) presents a solution for advanced targeting needs. By integrating electro-optical sensors with processing algorithms, the system ensures superior target identification, tracking, and engagement across diverse operational environments. The invention's adaptability and versatility make it a valuable asset for a wide range of applications.

SBATS (Sensor-Based Advanced Targeting System). SBATS utilizes military applications, such as on armored vehicles, naval vessels, or unmanned aerial vehicles (UAVs), to streamline the targeting process and enhance operational efficiency.

Sensor Integration: The sensor-based targeting system integrates multiple sensors, which can include radar sensors, sonar, electro-optical/infrared (EO/IR) sensors, laser rangefinders, or other specialized sensors.

Each sensor contributes specific data, such as radar signatures, thermal signatures, visual or infrared images, or acoustic signatures, for target identification.

Human-Machine Interface (HMI): A sensor-based focusing system that includes user interfaces and control systems, allowing operators to monitor and interact with the system.

In recent years, there has been a growing prevalence of employing drones, aircraft, and diverse types of flying objects, whether manned or unmanned, within both military and civilian domains.

Flying objects, whether of a straightforward or intricate nature, pose a technological challenge in terms of precise identification of their location, dimensions, and flight trajectory.

### SUMMARY OF THE INVENTION

According to some aspects, there is provided a system for detecting one or more flying objects, the system comprising: a sensing subsystem said sensing subsystem comprising: one or more energy sources connected to one or more laser sources, said laser sources are configured and enabled to transmit one or more board laser beams for scanning an area in the sky; one or more measurements units; one or more radars; one or more cameras; one or more thermic cameras; one or more microphones; one or more processors, configured to receive data from the sensing subsystem, said data including image data, laser data, microphone data and one or more processors, configured to receive data from the sensing subsystem and analyze the data to using one or more algorithms to identify the location or the or the distance of the flying object.

In an embodiment, the one or more laser devices are configured and enabled to scan an area between 45-90 degrees with respect to a Cartesian Coordinate System.

In an embodiment, the algorithm is one or more of: time-of-flight (TOF) method; triangulation method.

In an embodiment, the flying object is Half transparent object or fully transparent object or reflective object.

In an embodiment, the sensing subsystem comprises one or more sensors with a high sampling rate, operating at a sampling rate of for example up to 392,000 samples per second or more.

In an embodiment, the laser beams are configured to emit beams arranged in the configuration of a grid.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIG. 1 showing a flying object (e.g. aircraft) laser detection system 100, in accordance with embodiments;

FIG. 2A shows a flowchart of a method for detecting one or more flying objects in the sky using one or more laser sources, in accordance with embodiments.

FIG. 2B shows an example of a time-of-flight” (TOF) ranging or distance measurement;

FIG. 2C shows a network of laser beams in the form of a fan, in accordance with embodiments;

FIG. 2D shows an example of a laser system of FIG. 1, in accordance with embodiments;

FIG. 2E shows a method for detecting flying objects, in accordance with embodiments;

FIG. 3 shows a system for measuring the size of an object using lasers from different focal points, in accordance with embodiments;

FIG. 4 shows a graph of the voltage/received light at each cell in the sensor, in accordance with embodiments;

FIG. 5 shows a calculation performed based on the law of sines;

FIG. 6 shows an example of a method for measuring a partial transparent object, in accordance with embodiments.

FIG. 7 shows an example of a method for measuring a fully transparent object, in accordance with embodiments.

FIG. 8 shows an example of a method for reflective object measurement, in accordance with embodiments.

FIG. 9 shows an example of using more than one measurement unit or measurement device, in accordance with embodiments.

FIG. 10 shows an example of Three-Dimensional and/or Two-Dimensional Measurements, in accordance with embodiments.

FIG. 11 shows an example of utilizing the chromatic aberration method of light (dispersion to colors), in accordance with embodiments.

FIG. 12 shows an example of a distance measurement using SDL-based laser and optical fiber, in accordance with embodiments.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figure and described in the specification, but only as indicated in the accompanying claims, with the proper scope determined only by the broadest interpretation of said claims.

The present invention, in some embodiments thereof, relates to devices systems and methods for detecting flying objects/targets such as aircraft(s) more specifically, but not exclusively, to devices systems and methods using one or more laser devices or systems for detecting aircraft such as aircraft-based parachutes, drones, unmanned aerial vehicle (UAV), and the like.

Existing laser systems according to the prior art cannot monitor the space but rather measure the distance and size of an object only after detection of the flying object.

Additionally, the efficiency of the existing laser detection system is low, and they cannot detect immediately and accurately flying objects.

The laser system in accordance with embodiments include wide-spectrum laser, but not only that. It involves multiple laser beams scanning the sky continuously without interruption.

The configurations disclosed herein can be combined in one or more of many ways to provide improved flying object detection in the sky, for example detecting the penetration from the sky of various types of aircraft carriers including penetration from the sky of hundreds and more aircraft at the same time. One or more components of the configurations disclosed herein can be combined with each other in many ways.

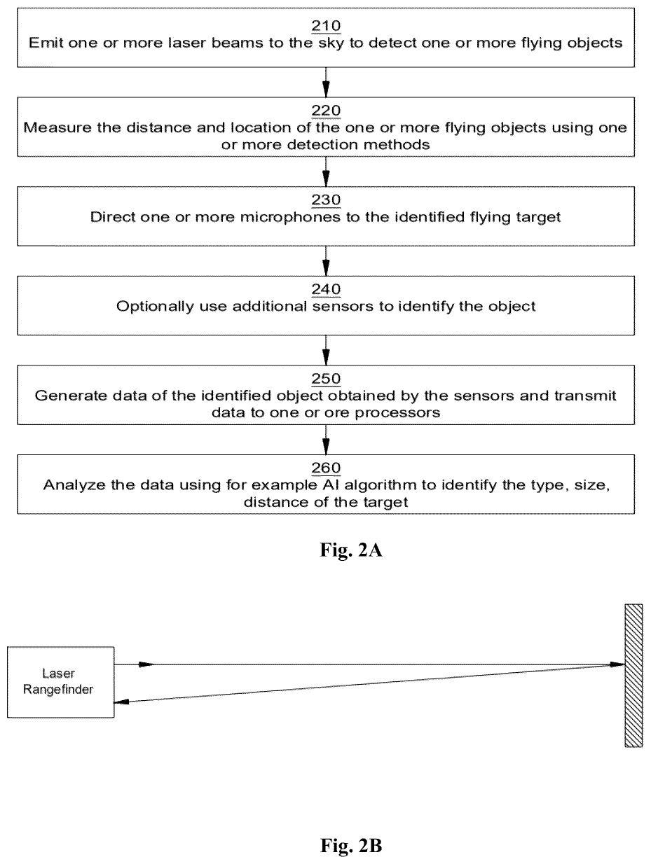

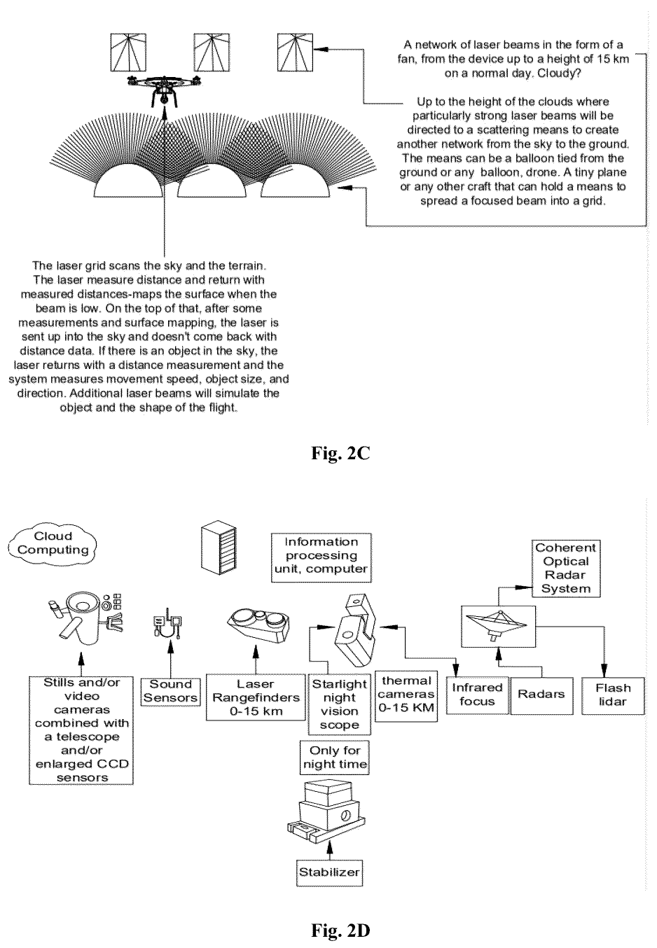

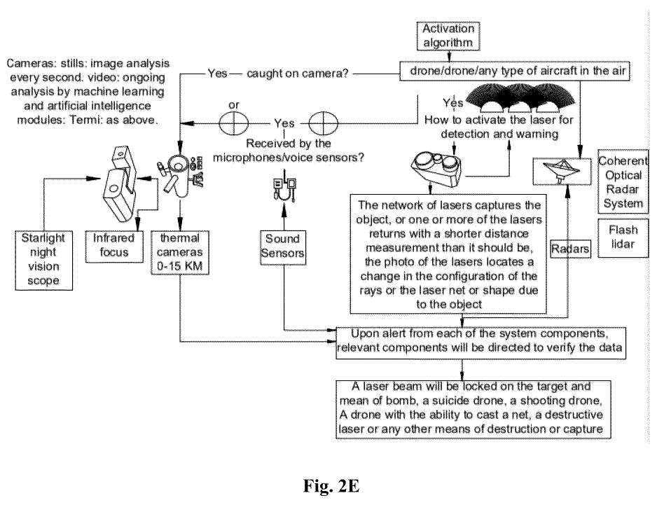

Devices systems and methods as described herein include a system for detecting one or more flying objects such as aircraft in the sky, the system comprising one or more laser devices configured and enabled to transmit one or more laser beams for example, board laser beams, for scanning an area, for example the sky. In some cases, as shown in FIG. 2C, each laser device may include a plurality of laser sources configured to transmit one or more laser beams and scan an area between 45-90 degrees with respect to a Cartesian Coordinate System.

Embodiments of the present disclosure comprise a laser emission system wherein the emitted laser moves continuously and projects laser beams in a grid pattern across the expanse of the sky.

For example, as shown in FIG. 2C the system may include one or more laser sources such as a network of laser sources configured to emit laser beams in the form of a fan and/or grid, from the device to a height of 1, 2, 3, 4, 5, 6, 7, 8, 9, 10, 11, 12, 1, 3, 14.15 km or more on a clear day and/or in a cloudy day. In some cases, the laser beams may be emitted to the height of the clouds where particularly strong laser beams will be directed by scattering means to create another network of laser beams emitted from the sky to the ground. The means can include a balloon tied from the ground or a balloon, drone, a tiny plane or any other craft that can hold a means to spread a focused beam into a grid.

In some embodiments, as shown in FIG. 2C The laser grid scans the sky and the terrain. The laser measures distances and returns with measured distances—maps the surface when the beam is low. On top of that, after some measurements and surface mapping, the laser is emitted up to the sky. If there is an object in the sky, the laser returns with a distance measurement and the system measures movement speed, object size, and direction.

Additional laser beams will simulate the object and the shape of the flight.

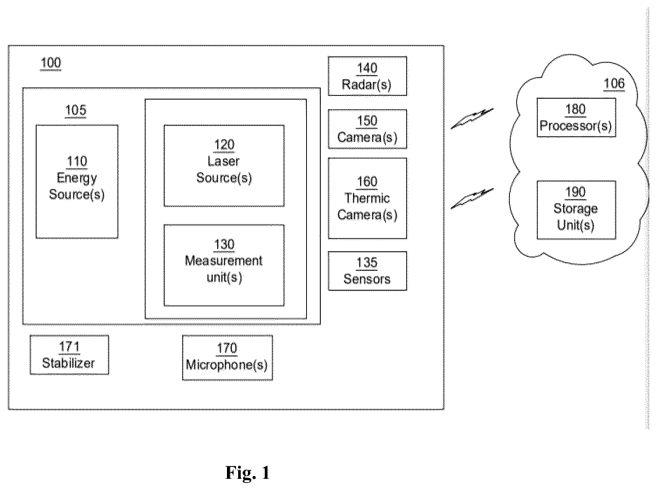

FIG. 2D shows the devices and subsystems included in a laser system such as the laser system of FIG. 1, in accordance with embodiments.

FIG. 2E shows the process of detecting the one or more flying objects, in accordance with embodiments.

In some embodiments, the laser system comprises one or more radar devices.

In some embodiments, the system comprises an optical device, such as a camera.

In some embodiments, the system includes one or more microphones.

In some embodiments, the system includes one or more thermic cameras.

The system may include or may be in communication with one or more processors configured and enabled to analyze one or more laser/optic/image data received from the system. In some embodiments, the one or more processors may use AI (Artificial Intelligence) methods for analyzing the captured data (e.g. laser data, optic data). In some embodiments, the analysis may be based on methods described on US patent application 2022/0120071.

In operation, the laser device is configured to move and/or rotate vertically and/or horizontally transmitting multiple laser beams scanning and forming a grid shape in the size of for example between 25 and 45 degrees as shown in FIG. 2C. Each or some of the transmitted laser beams measures an open space, in the in a frequency of between 1000-2000 nanometer, for example 1550 nanometer. The laser beams are configured to measure the distance of the identified target, by measuring the traveling time of the received laser signal from the system to the target. The spotting of the target may be of distance of 1,000-20,000 meters or more, for example 1500 meters.

The laser system may be formed as a dome structure, including for example a plurality of domes covering overlapping areas. Each system may be located in a different place, for example on the ground, mast, or wall.

The system may include or may be in communication with one or more air defense systems such as Iron Dome Systems to intercept and destroy the identified flying object (e.g. aircraft).

In accordance with embodiments, the laser systems, shaped as domes communicate between themselves, to create a three-dimensional image and identify the object. In cases where the information from one system is not clear enough, the other laser system will provide an indication and by using a combination of data received from the other systems with some components or all of them, the system can identify the target.

In some embodiments, the laser system may include one or more cameras such as thermic cameras configured and enabled to scan the sky all the time, specifically during night.

In some cases, the system further includes one or more listening devices, including sensitive microphones configured and enabled to hear and detect various types of engines, such as a drone engine. Once the system identifies an object in the sky it may report, for example in real-time, to one or more air defense systems to destroy the identified object.

Reference is now made to FIG. 1 showing a flying object (e.g. aircraft) laser detection system 100, in accordance with embodiments.

System 100 comprises a sensing subsystem 105, the sensing subsystem 105 comprises a generator/energy source 110, one or more laser sources 120 (including one or more laser diodes) and lenses, one or more measurement units 130, one or more radars 140, one or more cameras 150, and one or more thermic cameras 160, in accordance with embodiments.

In some embodiments, the laser sources may include one or more devices for the dispersion of a generated laser radiation, comprising a singular high-power laser beam to multiple beams, for example in a mesh-like pattern.

In some embodiments, the Dispersion device may be a Wave Dispersion Device, which is configured and enabled to generate from a single powerful laser beam one or more, grid-like laser beams.

In some embodiments, the one or more laser generators 120 may be wide band laser sources comprising dedicated lenses for generating one or more laser beams. In some embodiments, the generator 120 is designed to emit light in a broad and regular spectrum, ranging in millimeters. The laser sources include, but are not limited to, semiconductor lasers, solid-state lasers, and gas lasers. The system further incorporates energy source 110 such as a multi-source power generator, which efficiently harnesses energy from diverse means.

In some embodiments, the energy source 110 may be one or more of: solar energy source, wind turbine, batteries, electric generator, or any type of generator as known in the art.

The power generator is adaptable to solar energy through the integration of photovoltaic cells, wind energy through turbines, and hydro energy through water turbines. Additionally, the system is equipped with a traditional generator for generating electricity from mechanical energy. Direct current is also employed as a power source. The inclusion of various power generation means enhances the system's versatility, allowing it to operate seamlessly under different environmental conditions. This laser system represents a comprehensive and adaptable solution for applications requiring a wide-spectrum laser emission across varying millimeter ranges.

In some embodiments, the cameras may be standard camera apparatus, comprising for example video functionality and/or incorporating a telescopic feature, inclusive of still image capture capabilities.

According to some embodiments system 100 may include or may be in communication (wire or wireless) with one or more processors 180 configured and enabled to receive data from system the sensing subsystem and analyze the data, using one or more algorithms to identify the location and/or the size and/or the distance of the flying object.

In some embodiments, the processors comprise artificial intelligence (AI) software incorporating or in communication with machine learning libraries, including but not limited to TensorFlow and PyTorch. Additionally, it features a communication system facilitating interaction with remote servers and with processors employing MEGA DATA type.

In some embodiments, the system 100 may include or may be in communication with one or more storage unit(s) for storing the received data.

In some embodiments, the one or more processors 180 may be located in a cloud based local or remote server 105.

According to one embodiment, the laser sources 120 may include or may be embedded with the measurement unit 130, such as a laser measurement unit configured and enabled to measure the distance of an object, for example, the flying object (e.g. aircraft) from a predefined point, such as the distance of the object from the system 100 or from any selected point.

According to one embodiment, the one or more radars may be narrow beam radars.

According to some embodiments, the system may include one or more sensors 135 such as electro optic (EO) sensors and/or infrared (IR) sensors.

In accordance with embodiments, the electro-optical module of the sensors is configured to capture images within the visible light spectrum, whereas the infrared module is designed to discern thermal signatures emanating from objects, thereby enabling target identification under conditions of diminished or obscured illumination.

According to one embodiment, the one or more microphones 170 may be in the form of electronic listening plates.

In some embodiments, the microphones 170 may include heightened sensitivity, incorporating machine learning algorithms, designed for identifying diverse categories of sounds, including but not limited to the sound of aircraft in flight, malfunctioning parachute noises, drone sounds, tethered balloon sounds, and the like.

According to one embodiment, the thermic cameras 160 may be broad band thermic cameras.

According to one embodiment, the system may include a night vision device or night vision scope. A starlight scope, also known as a night vision device or night vision scope, is a device designed to amplify existing light in the environment, including moonlight and starlight, to provide enhanced visibility in low-light conditions or complete darkness. It uses technology such as image intensification to convert ambient light into a visible image. These scopes are commonly used by military and law enforcement for surveillance, reconnaissance, and other nighttime operations. The term “starlight scope” reflects its ability to amplify and utilize faint light sources, including starlight, to create a visible image.

According to one embodiment, the laser device 105 and cameras 160 may include or may be in communication with one or more processors configured to receive data such as image date and operate detection methods for identifying the flying objects in the sky such as aircraft, for example in direct vertical for example gliders or any type of aircraft which fly in straight lines in the sky. Specifically, a drone or any other flying device flies in straight lines, as opposed to winged creatures that also exhibit characteristic vertical rotations in flight. The purpose of straight vertical refers to teaching the system using for example AI methods how flying devices navigate vertically and learning to identify them in real-time images, (e.g. both stills and videos, using all the sensors and components of the system.

In some embodiments, the system comprises a set of comparison engines that utilize deep learning algorithms to analyze and compare data sets. These engines are configured to learn patterns and relationships within the data, enabling more nuanced and accurate comparisons. The incorporation of AI further enhances the adaptability of the system, allowing it to dynamically adjust to evolving data characteristics.

The method involves training the comparison engines on diverse datasets, enabling them to generalize patterns and make informed comparisons across a wide range of inputs. The deep learning architecture enables the engines to automatically extract relevant features from the data, eliminating the need for manual feature engineering.

Furthermore, the system incorporates a feedback loop mechanism, where the comparison engines continuously learn and adapt based on user feedback and evolving data patterns. This iterative learning process enhances the system's performance over time, making it well-suited for dynamic and evolving datasets.

In some embodiments, the following sensors may be included in system 100: Temperature and Humidity Sensor:

The present invention incorporates a high-precision temperature sensor to measure ambient conditions.

A gas sensor array is utilized to detect and quantify the presence of various gases in the environment. Examples include MQ series gas sensors for detecting carbon monoxide, methane, and volatile organic compounds (VOCs).

### Light and UV Sensor:

To monitor light intensity and UV radiation, a light and UV sensor is integrated into the system. Example sensor: TSL2561—Luminosity Sensor.

### Motion Sensor:

The invention includes a motion sensor to detect movement within the monitored area. PIR (Passive Infrared) sensors, such as the AM312, can be employed for this purpose. Image Sensor:

An image sensor captures visual information, providing a comprehensive view of the environment. Example sensor: OV5640—5MP Camera Module.

### Sound Sensor:

To monitor acoustic conditions, a sound sensor is incorporated. An example is the Adafruit Electret Microphone Amplifier.

### Proximity Sensor:

Proximity sensors are used to detect the presence or absence of an object within a certain range. Example sensor: VL6180X—Proximity Sensor.

### Pressure Sensor:

A pressure sensor is employed to measure atmospheric pressure changes. Example sensor: BMP180—Barometric Pressure Sensor.

FIG. 2A shows a flowchart of a method 200 for detecting one or more flying objects in the sky using one or more laser sources, in accordance with embodiments.

At step 210 one or more laser beams are emitted to the sky. In one embodiment the one or more laser beams are emitted in a broad beam configuration, comprising a plurality of invisible light rays arranged for example in a grid-shaped pattern directed towards the sky.

In some cases, for protecting small areas, for example in the range of hundreds of meters or more, the system may be positioned 500 meters above the area which need to be protected.

At step 220, the laser beams reflected from the flying object ray are utilized to measure the distance of the flying object, in accordance with embodiments. The location of the object may be measured according to one or more of the following methods:

The system emits a plurality of laser beams that interact with each other at a distance of around 500 meters or more. When a target or targets, such as a flying target intersects with the laser beams, it is identified, simultaneously, or almost simultaneously another laser beams locks onto the target or targets, measuring distance, height, direction, and size.

At step 230 one or more microphones are directed to the identified flying target. Additionally, or optionally, acoustic sensors are used to identify the engine sound of the identified target or any type of sound of a flying target. At the following step 240 other sensors are optionally used to identify the flying target, such as the cameras 150, video cameras, thermic cameras 160, the radars 140 and other electro-optic sensors included in the system. At step 250 the sensors (such as the sensors of steps 240 and 230) generate data including for example optic data, pattern data, reflected laser data and the like obtained by the various sensors and are transmitted to one or processors such as processors 180. At step 260 the processors analyze the data using for example AI algorithm to identify the type, size, distance of the target. In some cases, the processor is configured to generate an image of the identified flying object/target. Once identified, firing system such as missiles or drones, or any other firing means developed in the future will be activated to destroy the identified flying object.

It is stressed that the system identification process is fast, of less the milliseconds.

Additionally, in some cases, the system may be positioned in a height of more than 100, 200, 300, 400, 5000 meters above the area which requires protection.

According to another embodiment, a laser system such as the laser system 100 may be positioned and emit laser beams scanning the sky at an angle of 25 degrees and more in a movement of 130 degrees. The laser beams are configured and enabled to continually measure the distance of objects in the sky. The laser sources may change their horizontal location.

It is stressed that the laser sources emit broad laser beams.

According to one embodiment, the emitted laser beams interfere with each other at a known height or exit without returning because they are essentially aimed towards the sky. If the laser hits an object at an angle of 25 degrees until the end of the impacts, the laser creates a simulation of the scanned surface area (e.g. of a tree movement such as leaves branches) at a known distance, and so on. An AI system will identify the flying objects, and a regular camera will train the system to compare between the generated simulation created based on the reflected laser beams and the received image.

The systems and methods, in accordance with embodiments, are configured and enabled to detect and identify any change in the movement and/or flight of the flying object, such as height/direction/velocity of the flying object.

In accordance with embodiment, once the flying object is identified it may be destroyed automatically, and/or once the system is confident on the identification of the flying object.

In an embodiment, upon the confirmation of a positive and precise identification of the flying object, the destruction of the object may be initiated.

In some embodiments, in an angle of 45 degrees or more, it is likely that any reflected laser beam will serve as an initial indication, followed by the use of various system means described above, up to the neutralization of the threat.

In accordance with embodiments, the system includes methods for capturing images of the laser beams heating the targets and revealing distinctive patterns. This can streamline and cost-effectively expedite the process of identifying the targets since there is no need to analyze dozens or hundreds of beams simultaneously. Instead, a characteristic image(s) of the laser grid in actual flight is obtained, along with distance measurement and the closure of the object's identification through other components of the system, whether one or all of them. For example, if the laser grid captures an object, and it's unclear to the system whether it's a bird, balloon, or UAV, the system will redirect a microphone to listen for characteristic engine noises. Simultaneously and/or alternatively, it may capture thermal images to detect movement, and/or capture regular images to identify drones without sound and without a heat signature. The following methods may be used along with other methods to identify the object (e.g. with the microphones and thermal images and the like)

### Time-of-Flight” (TOF) Ranging or Distance Measurement

Calculating the range based on the time duration required for the transmitted laser beams to return to the device.

This method is primarily accepted for large ranges and relatively low accuracy (millimeters to centimeters). The device is referred to as a Long-Range Laser Meter (LRLM).

This method may be or may include methods as used by a laser rangefinder, also known as a laser telemeter. A laser rangefinder is a rangefinder that uses a laser beam to determine the distance to an object. The most common form of laser rangefinder operates on the time-of-flight principle by sending a laser pulse in a narrow beam towards the object and measuring the time taken by the pulse to be reflected off the target and returned to the sender.

As the laser beams are emitted at the speed of light and returns promptly, the distance calculation is based on the general formula:

D [m]=V [m/s]*t [sec],

Meaning, the distance is equal to the product of the speed and time. In our case, the time considered for calculating the distance is half of the round-trip time of the light beam, since the laser beam departs and returns, and the speed is the speed of light (C), as illustrated in FIG. 2B. In this case, the specific Eq is:

d=C*t/2

Where: d—distance and t—time

The accuracy of this device and method is primarily determined by the response speed of the receiver within the device and its capability to discern very small-time differences, typically on the order of at least nanoseconds.

### Location Measurement Using the Triangulation Method

Unlike laser rangefinders as described above, where the range is calculated based on the time it takes for a laser beam to reach the target and return to the device/system, these devices and methods operate according to the return location of the laser in the laser device.

Each laser according to this method is designed for short ranges and high accuracy—on the order of micrometers and sub-micrometers.

### Principle of Operation of the Device:

a. A laser beam is emitted towards the measured target and returns to the device.

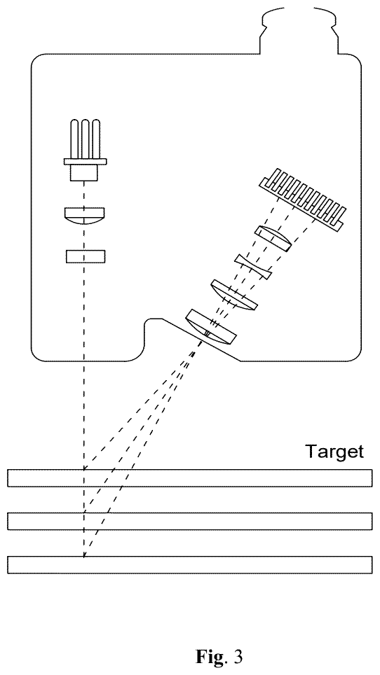

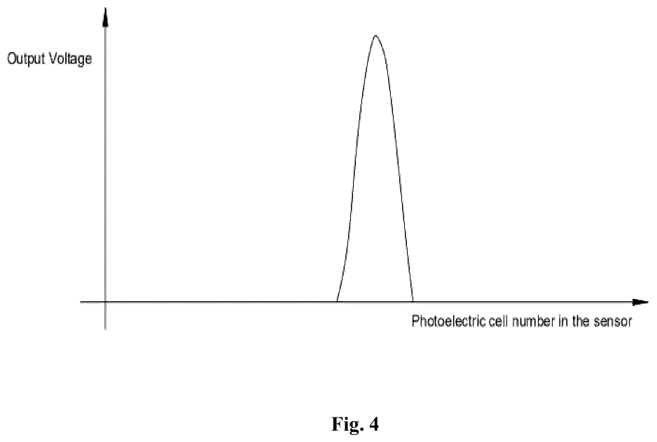

b. A sensor for detecting the impact location of the return laser signal is installed in the device. This sensor can be an analog type such as PSD (Position Sensing Detector) or digital e.g., a row of photovoltaic cells in a line, which change their output voltage according to the intensity of the laser light frequency. These sensors may be CCD (Charge Coupled Device) or CMOS (Complementary Metal-Oxide Semiconductor) types. The location is determined by the point of impact of the laser on the sensor. A schematic view of the laser device as operated according to the triangulation method and in accordance with embodiments is illustrated in FIG. 3. FIG. 3 shows a system for measuring the size of an object using lasers from different focal points. The obtained result of the triangulation measurement is a graph of the voltage/received light at each cell in the sensor as shown in FIG. 4.

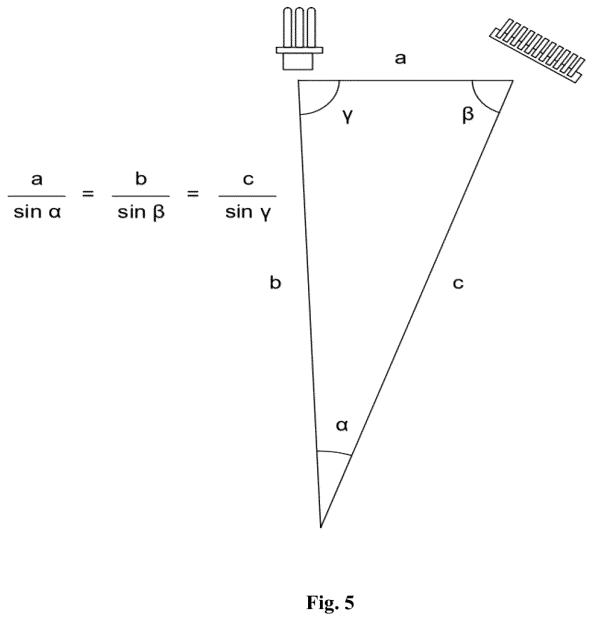

c. The calculation of the distance from the device (the laser device) is performed by averaging the measured power and creating the “center of mass” of the graph or by calculating the maximum point in the graph. After finding the main determining point on the sensor, representing the distance of the measured object, a calculation is performed based on the law of sines of a triangle as shown in FIG. 5, including in each vertex of the triangle, respectively: laser generators and an electro-optical light sensor, including background computing capability for measuring the size of the detected object. The distance ‘a’ and the angle ‘y’ our known (according to the know production details of the laser device) the angle R is calculated according to the optic design of the device.

d. The distance ‘b’ from the object is measured according to Eq:

$$b = a \frac{sin β}{sin α}$$

It is stressed that the accuracy of a system using this method is determined by the precision of the optics, the laser beam's thickness, sensor resolution, and signal sampling frequency.

### Examples of Identifying and Detecting Objects

### Half Transparent Object Measurement

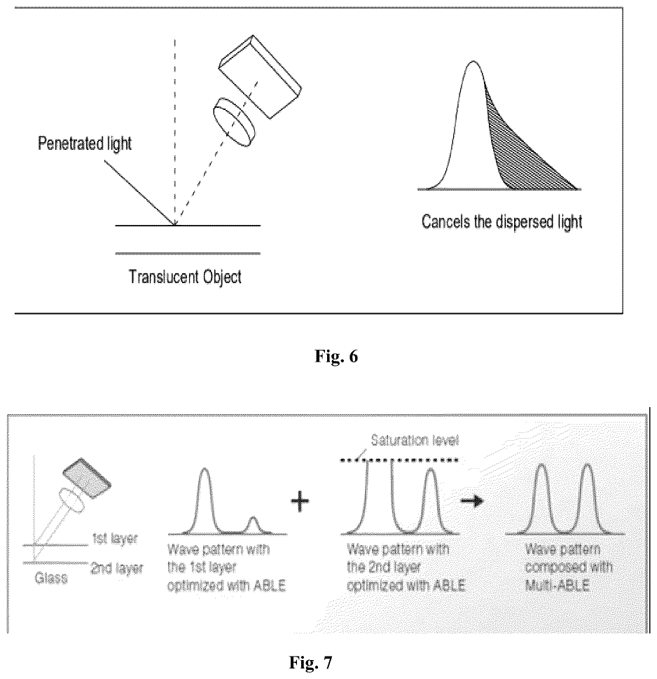

FIG. 6 shows an example of a method for measuring a partial transparent object, in accordance with embodiments.

In accordance with embodiments low signals returns such as 10 cm or more, which are derived from the lower-measured part of the material may be ignored, and focus on signals measured on the peak, which represent the material's maximum point.

### Fully Transparent Object Measurement

FIG. 7 shows an example of a method for measuring a fully transparent object, in accordance with embodiments.

In accordance with embodiments, two signals are received by the sensor. One from the top section of the glass object (e.g. the fully transparent object) and one from the bottom part.

According to one embodiment, each of the received signals can be checked separately. This way, it is possible to obtain the range of the glass surface, or ignore the first wave of signals and measure the distance from the bottom part, while disregarding the existence of the glass (e.g. the fully transparent object). Additionally, it is possible to measure the thickness of the glass by measuring the difference in distance from the top of the glass to the bottom.

### Reflective Object Measurement

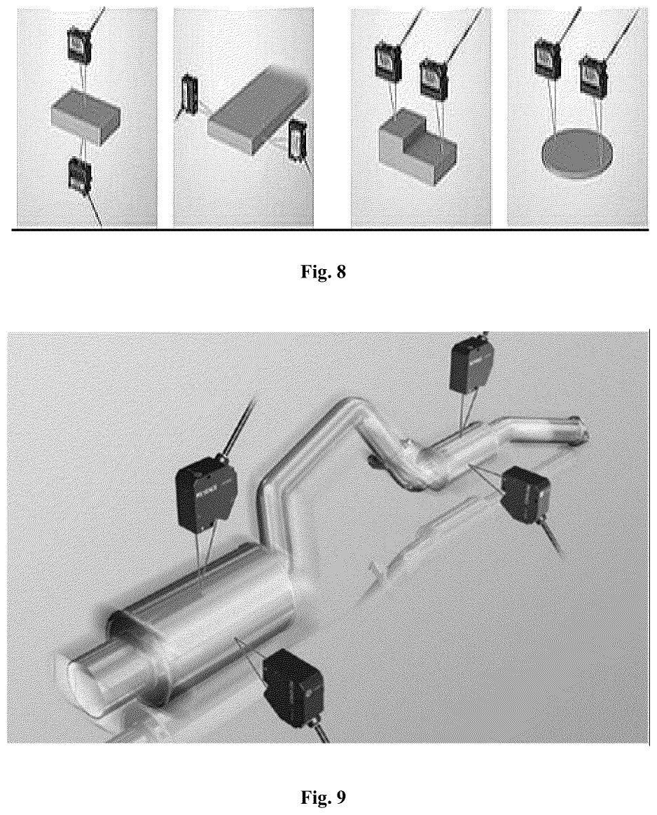

FIG. 8 shows an example of a method for reflective object measurement, in accordance with embodiments.

In accordance with embodiments the present invention enables the measurement of reflective objects, particularly those with reflective surfaces, such as mirrors. The algorithm implemented in the device, such as in the processor(s) of the laser source 120, effectively mitigates the impact of light reflections that penetrate through the specular coating, yielding precise measurement results.

In some cases, it may be needed to adjust the installation angle of the sensor concerning the measured ‘reflective’ object for optimal functionality and accuracy.

Using More than One Measurement Unit or Measurement Device

FIG. 9 shows an example of using more than one measurement unit or measurement device, in accordance with embodiments.

The utilization of multiple measurement devices facilitates the automated computation of surface angles, dimensional variances, thickness, and the like.

### High-Speed Measurements—Vibration Analysis

In accordance with embodiments a laser system such as system 100 may comprise one or more sensors with a high sampling rate, operating at a sampling rate of for example up to 392,000 samples per second or more. In such cases, it is possible to analyze the location at multiple points and obtain information about the speed and acceleration of the measured flying object at each measured point.

Three-Dimensional and/or Two-Dimensional Measurements

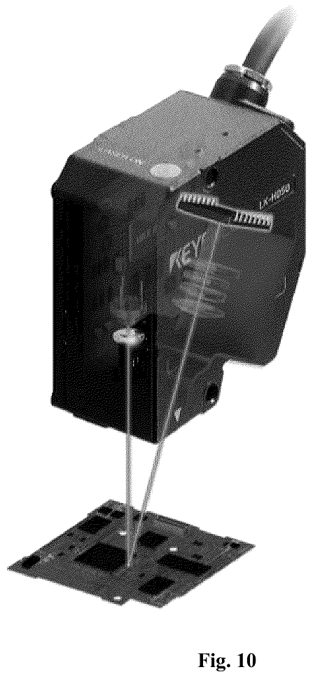

FIG. 10 shows an example of Three-Dimensional and/or Two-Dimensional Measurements, in accordance with embodiments.

Systems and methods in accordance with embodiments may include using two-dimensional CCD and/or CMOS sensors, constructed in the form of a matrix of sensors (instead of a row of sensors—similar to that found in digital cameras) used to perform two-dimensional measurements along a laser beam in the form of a line, instead of a point.

The systems and methods in accordance with embodiments, are configured and enabled to detect and track the trajectory the flying object and create a three-dimensional profile of the flying object. In addition, the systems and methods in accordance with embodiments, are configured and enabled to measure angles, positions, height differences, and the like, of the flying object, for example in real-time, while the object is in movement.

### Utilizing the Chromatic Aberration Method of Light (Dispersion to Colors)

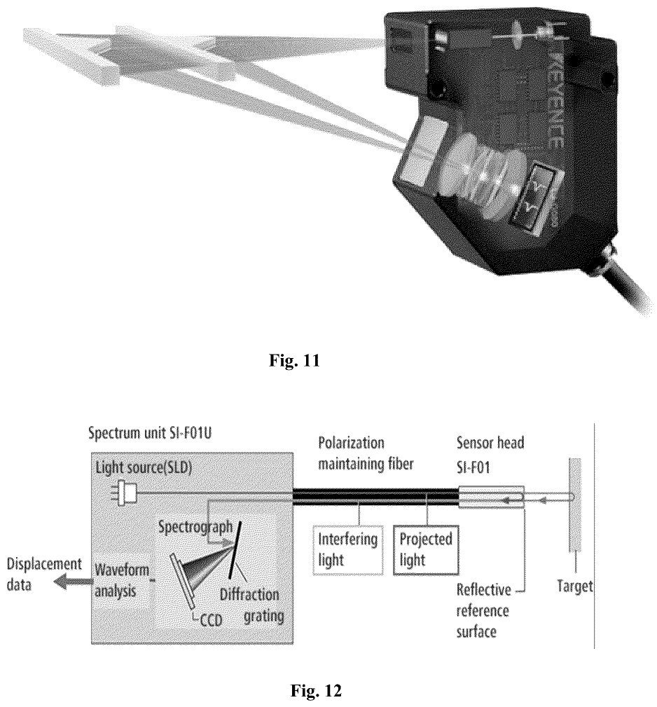

FIG. 11 shows an example of utilizing the chromatic aberration method of light (dispersion to colors), in accordance with embodiments.

Systems and methods in accordance with embodiments may include using chromatic aberration methods of light (dispersion to colors) for measuring small ranges and a resolution of up to one nanometer (0.000001 millimeter). The systems such as system 100, in accordance with embodiments may utilize the physical property of light, which refracts when passing from one medium to another with different density (Snell's Law) to measure the distance and/or location of the flying object.

The present invention comprises detecting the distance and location of a flying object utilizing the unique properties of optical fibers. Unlike traditional methods that rely on the propagation of light through air, this patented technology capitalizes on the disparities in the speed of light within the material of an optical fiber. The distinguishing characteristic lies in the fact that each wavelength of light travels at a different velocity within the fiber.

Consequently, this variance in speed induces distinct angles of light refraction for each wavelength, corresponding to the specific color of light. By precisely measuring these differential refraction angles, the system can accurately determine the distance and location of a flying object, offering a groundbreaking approach to object detection and tracking in three-dimensional space. This innovation represents a significant advancement in optical sensing technologies with broad applications in fields such as surveillance, aerospace, and autonomous navigation.

### Method and System for Distance Measurement Using SLD-Based Laser and Optical Fiber

The invention discloses a distance measurement system employing a Super luminescent Light-emitting Diode (SLD) laser. The SLD emits light in a broad spectrum, including white light. The emitted light travels through a precisely aligned optical fiber, which reflects the light from both the fiber end and the measured object. A semi-transparent reflective surface at the fiber end facilitates reflection from the optical fiber and the measured object. The reflected light consists of the reflection from the optical fiber end and the measured object. It undergoes refraction using a special mirror, and the light scatters onto a CCD sensor.

The sensor receives two reflections, one from the measured object and the other from the optical fiber end. The distance calculation is performed by analyzing the color distribution of the two signals on the sensor. Specifically, the system takes into account the distance between identical color pairs on the sensor, enabling an accurate computation of the distance between the optical fiber end and the measured object.

### Distance Measurement Using SLD-Based Laser and Optical Fiber

FIG. 12 shows an example of a distance measurement using SDL-based laser and optical fiber, in accordance with embodiments.

In accordance with embodiments there is provided method and system for distance measurement using SLD-based Laser and Optical Fiber.

The SLD emits light in a broad spectrum, including white light. The emitted light travels through a precisely aligned optical fiber, which reflects the light from both the fiber end and the measured object. A semi-transparent reflective surface at the fiber end facilitates reflection from the optical fiber and the measured object. The reflected light consists of the reflection from the optical fiber end and the measured object. It undergoes refraction using a special mirror, and the light scatters onto a CCD sensor.

The sensor receives two reflections, one from the measured object and the other from the optical fiber end. The distance calculation is performed by analyzing the color distribution of the two signals on the sensor. Specifically, the system takes into account the distance between identical color pairs on the sensor, enabling an accurate computation of the distance between the optical fiber end and the measured object.

SLD Emission: The process begins with the emission of light from the Super luminescent Light-emitting Diode (SLD). The emitted light includes a broad spectrum, resembling white light.

Optical Fiber Transmission: The emitted light is transmitted through a precisely aligned and coated optical fiber, ensuring optimal light transmission.

Reflection from Fiber End and Object: The light passes through the optical fiber and reflects off a semi-transparent reflective surface at the fiber end. Simultaneously, it reflects off the measured object.

Composition of Reflected Light: The reflected light comprises two components—the reflection from the optical fiber end and the reflection from the measured object.

Refraction and Scattering: The reflected light undergoes refraction using a specialized mirror, and the scattered light is directed onto a CCD sensor.

A sensor such as CCD Sensor Reception: The sensor (e.g. CCD sensor) receives two reflections—one from the optical fiber end and the other from the measured object.

Distance Calculation: The system calculates the distance by analyzing the color distribution of the two reflections on the sensor. This involves considering the distance between identical color pairs on the sensor.

Accurate Distance Measurement: The final output provides an accurate measurement of the distance between the optical fiber end and the measured object based on the analysis of color distribution.

In accordance with some embodiments, upon receipt of an indication of a flying object (e.g. aerial vehicle manned or unmanned), a systematic measurement of the size of the detected object is performed. This process includes using for example directed auditory examination methods and systems using for example listening devices, alongside the utilization of both thermal and standard cameras to facilitate precise target identification.

By employing this method, the invention offers a precise and efficient distance measurement solution using SLD-based laser technology and optical fiber.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of those elements. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for detecting one or more flying objects, the system comprising: a sensing subsystem said sensing subsystem comprising:
one or more energy sources connected to one or more laser sources, said laser sources are configured and enabled to transmit one or more board laser beams for scanning an area in the sky;
one or more
measurements units;
one or more radars;
one or more cameras;
one or more thermic
cameras; one or
more microphones;
one or more processors, configured to receive data from the sensing subsystem, said data including image data, laser data, microphone data and analyze the data to using one or more algorithms to identify the location or the or the distance of the flying object.

2. The system of claim 1 wherein the one or more laser devices are configured and enabled to scan an area between 45-90 degrees with respect to a Cartesian Coordinate System.

3. The system of claim 1 wherein the algorithm is one or more of: time-of-flight (TOF) method;
triangulation method.

4. The system of claim 1 wherein the flying object is Half transparent object or fully transparent object or reflective object.

5. The system of claim 1 wherein the sensing subsystem comprises one or more sensors with a high sampling rate, operating at a sampling rate of for example up to 392,000 samples per second or more.

6. The system according to claim 1, wherein the laser beams are configured to emit beams arranged in the configuration of a grid.
